(19) United States
(12) Patent Application Publication
(10) Pub. No.: US 2019/0044967 A1
(43) Pub. Date: Feb. 7, 2019

(54) IDENTIFICATION OF A MALICIOUS STRING

(71) Applicant: Intel Corporation, Santa Clara, CA (US)

(72) Inventors: Vadim Sukhomlinov, Santa Clara, CA (US); Kshitij A. Doshi, Tempe, AZ (US); Tamir Damian Munafo, Naale (IL)

(73) Assignee: Intel Corporation, Santa Clara, CA (US)

(21) Appl. No.: 16/128,704

(22) Filed: Sep. 12, 2018

(51) Int. Cl. H04L 29/06; G06K 9/00

(52) U.S. Cl. CPC H04L 63/1425; G06K 2209/01; G06K 9/00442

(57) ABSTRACT

Particular embodiments described herein provide for an electronic device that can be configured to identify a string of data to be displayed on a display, render the string to create an image that represents how the string of data will be displayed on the display, perform object character recognition (OCR) on the image to create a string of OCR data, compare the string of OCR data to the string of data to determine if there is a difference between the string of OCR data and the string of data, and communicate an alert to a user when there is a difference between the string of OCR data and the string of data. In an example, the string of data is a malicious string link to a malicious website.

### TECHNICAL FIELD

This disclosure relates in general to the field of information security, and more particularly, to the identification of a malicious string.

### BACKGROUND

The field of network security has become increasingly important in today's society. The Internet has enabled interconnection of different computer networks all over the world. In particular, the Internet provides a medium for exchanging data between different users connected to different computer networks via various types of client devices. While the use of the Internet has transformed business and personal communications, it has also been used as a vehicle for malicious operators to gain unauthorized access to computers and computer networks and for intentional or inadvertent disclosure of sensitive information.

Malicious software (“malware”) that infects a host computer may be able to perform any number of malicious actions, such as stealing sensitive information from a business or individual associated with the host computer, propagating to other host computers, and/or assisting with distributed denial of service attacks, sending out spam or malicious emails from the host computer, etc. Hence, significant administrative challenges remain for protecting computers and computer networks from malicious and inadvertent exploitation by malicious software.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram of a communication system for the identification of a malicious string in accordance with an embodiment of the present disclosure;

FIG. 2 is a simplified block diagram of a portion of a communication system for the identification of a malicious string in accordance with an embodiment of the present disclosure;

FIG. 3 is a simplified flowchart illustrating potential operations that may be associated with the communication system in accordance with an embodiment;

FIG. 4 is a simplified flowchart illustrating potential operations that may be associated with the communication system in accordance with an embodiment;

FIG. 5 is a block diagram illustrating an example computing system that is arranged in a point-to-point configuration in accordance with an embodiment;

FIG. 6 is a simplified block diagram associated with an example ARM ecosystem system on chip (SOC) of the present disclosure; and

FIG. 7 is a block diagram illustrating an example processor core in accordance with an embodiment.

The FIGURES of the drawings are not necessarily drawn to scale, as their dimensions can be varied considerably without departing from the scope of the present disclosure.

### DETAILED DESCRIPTION OF EXAMPLE EMBODIMENTS

The following detailed description sets forth examples of apparatuses, methods, and systems relating to a system for the identification of a malicious string in accordance with an embodiment of the present disclosure. Features such as structure(s), function(s), and/or characteristic(s), for example, are described with reference to one embodiment as a matter of convenience; various embodiments may be implemented with any suitable one or more of the described features.

In the following description, various aspects of the illustrative implementations will be described using terms commonly employed by those skilled in the art to convey the substance of their work to others skilled in the art. However, it will be apparent to those skilled in the art that the embodiments disclosed herein may be practiced with only some of the described aspects. For purposes of explanation, specific numbers, materials, and configurations are set forth in order to provide a thorough understanding of the illustrative implementations. However, it will be apparent to one skilled in the art that the embodiments disclosed herein may be practiced without the specific details. In other instances, well-known features are omitted or simplified in order not to obscure the illustrative implementations.

In the following detailed description, reference is made to the accompanying drawings that form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the following detailed description is not to be taken in a limiting sense. For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B, and C).

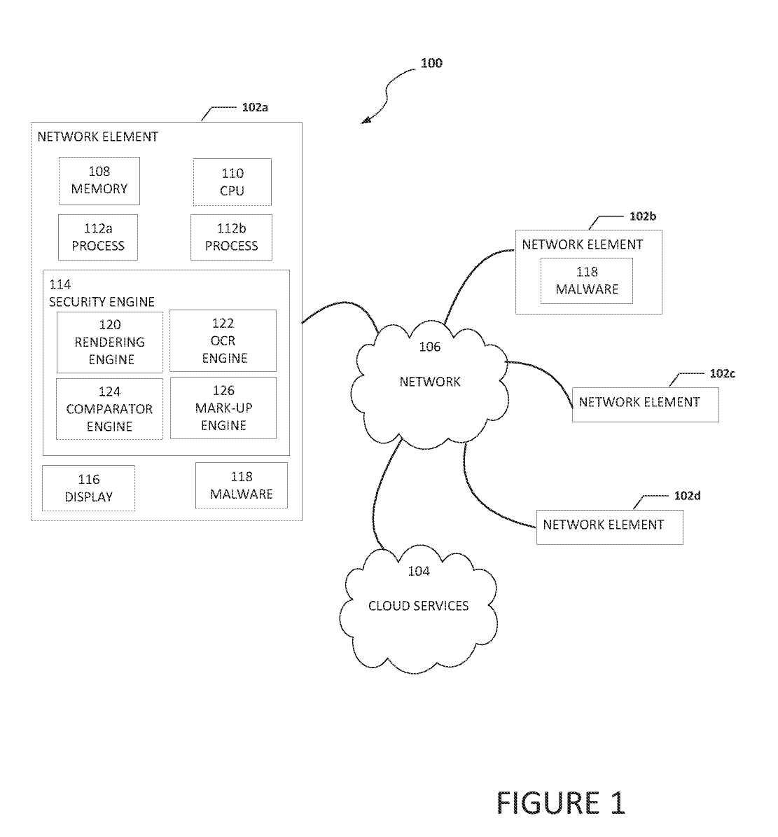

FIG. 1 is a simplified block diagram of a system 100 for the identification of a malicious string in accordance with an embodiment of the present disclosure. As illustrated in FIG. 1, an embodiment of system 100 can include network elements 102a-102d and cloud services 104. Network elements 102a-102d and cloud services 104 may be in communication with each other using network 106.

Each of network element 102a-102d can include memory, a computer processing unit (CPU), one or more processes, a security engine, and a display. For example, as illustrated in FIG. 1, network element 102a includes memory 108, one or more CPUs 110, one or more processes 112a and 112b, a security engine 114, and a display 116. Each of processes 112a and 112b may be a computer program, function, virtual machine, etc. Security engine 114 can include a rendering engine 120, an object character recognition (OCR) engine 122, a comparator engine 124, and a mark-up engine 126. In an example, network element 102a can include malware 118.

Elements of FIG. 1 may be coupled to one another through one or more interfaces employing any suitable connections (wired or wireless), which provide viable pathways for network (e.g., network 106) communications. Additionally, any one or more of these elements of FIG. 1 may be combined or removed from the architecture based on particular configuration needs. System 100 may include a configuration capable of transmission control protocol/Internet protocol (TCP/IP) communications for the transmission or reception of packets in a network. System 100 may also operate in conjunction with a user datagram protocol/IP (UDP/IP) or any other suitable protocol where appropriate and based on particular needs.

In an example, system 100 can be configured to help verify that what is shown on display 116 to a user is a correct representation of what a user expects (what is in the content) and that the user interacts with content that is properly displayed. System 100 is applicable across a wide range of applications (e.g., browsers, enterprise document management and creation systems, digital signature applications, content filtering and navigating systems, etc.) and helps to ensure that the user operates with content that is properly displayed. For example, system 100 not only authenticates machine content but also authenticate user's content displayed on a display. More specifically, system 100 can help provide an electronic signature that authenticates the content displayed on display 116 to the user as well as the machine content. Security engine 114 can render data (e.g., a string of data) and determine how the data is or will be presented on display 116 to the user. Security engine 114 can then apply OCR to the displayed image and match the OCR with the source data or string to determine if they are the same. When performing the OCR, security engine 114 can take into account localization settings of the user. If there is a difference between the displayed image and the source data or string, security engine 114 can identify the differences and alert the user to the differences. The alert can include visual cuing on display 116, such as employing different colors, bolding, highlighting, italicizing, underlining, increasing font size, etc. Security engine 114 can be configured to implement rendering and reverse OCR with only current language alphabets active or in use by the user.

More specifically, rendering engine 120 can be configured to analyze source data (e.g., a string) and determine the content that is or will be displayed to the user on display 116. OCR engine 122 can be configured to apply OCR to the content that is or will be displayed on display 116 to the user and render text from the content. Comparator engine 124 can be configured to compare the original source data with the rendered text from the OCR. Mark-up engine 126 can be configured to alert the user of any differences in the original source data and the rendered text from the OCR.

In an illustrative example, the string “A_WEβSITE.COM” may be the original source data and the string “A_WEβSITE.COM” is displayed on the display to the user. The string “A_WEβSITE.COM” looks very similar to the string “A_WEβSITE.COM” and the user may be tricked into thinking “A_WEβSITE.COM” is a string or link to “A_WEβSITE.COM”. Note that as used herein, the string, link, term, etc. “A_WEβSITE.COM” is intended to be a fictional non-malicious website and is used for illustration purposes. Rendering engine 120 can determine that “A_WEβSITE.COM” is or will be displayed to the user on display 116. OCR engine 122 can apply OCR to “WEβSITE.COM” and render the text “A_WEβSITE.COM.” Comparator engine 124 can compare the original source data of “A_WEβSITE.COM” with the rendered text “A_WEβSITE.COM” from the OCR of the content. Mark-up engine 126 can alert the user of the difference between the “B” in “A_WEβSITE.COM” and the “β” in “A_WEβSITE.COM” to help the user identify the malicious string. For example, the B″ in “A_WEβSITE.COM” and the “β” in “A_WEβSITE.COM” may be bolded (e.g., “A_WEβSITE.COM” and “A_WEβSITE.COM”), underlined (e.g., “A_WEβSITE.COM” and “A_WEBSITE.COM”), a bigger font (e.g., “A_WEβSITE.COM” and “A_WEβSITE.COM”) and/or some other means that can alert the user of the difference between the “B” in “A_WEβSITE.COM” and the “β” in “A_WEβSITE.COM.”

In another illustrative example, the string “A_WEβSITE.COM” may be the original source data and the text “A_WEBSITE.COM” is displayed on the display to the user. Rendering engine 120 can determine that “A_WEBSITE.COM” is or will be displayed to the user on display 116. OCR engine 122 can apply OCR to “A_WEBSITE.COM” and render the text “A_WEBSITE.COM.” Comparator engine 124 can compare the original source data of “A_WEβSITE.COM” with the rendered text “A_WEBSITE.COM” from the OCR of the content. Mark-up engine 126 can alert the user of difference between the “B” in “A_WEBSITE.COM” and the “β” in “A_WEβSITE.COM” to help the user identify the malicious string.

For purposes of illustrating certain example techniques of system 100, it is important to understand the communications that may be traversing the network environment. The following foundational information may be viewed as a basis from which the present disclosure may be properly explained.

Malicious software (“malware”) that infects a host computer may be able to perform any number of malicious actions, such as stealing sensitive information from a business or individual associated with the host computer, propagating to other host computers, assisting with distributed denial of service attacks, sending out spam or malicious emails from the host computer, etc. Hence, significant administrative challenges remain for protecting computers and computer networks from malicious and inadvertent exploitation by malicious software and devices. One way malicious operators can infect a host computer is to use spoofing with a malicious string.

Generally, spoofing is where a malicious operator or application masquerades as another legitimate operator or application by falsifying data such as a string of data. During a spoofing attack, the malicious operator or application takes advantage of the fact that many users overlook subtle changes in text such as email address or domain names and trick the user into clicking a malicious string or engaging in communications with a malicious operator. The attacker or malware can build unscrupulous websites and email messages that can trick users into downloading, signing, and compromising the user's privacy or security by employing font and glyph tricks to make the user think they are visiting reputed domains. For example, a spoofed Uniform Resource Locator (URL) can appear as a legitimate string link to a website that seems familiar but actually is a malicious string link to a malicious website or malicious location. In another example, a spoofed email address, chat request, etc. can appear as legitimate but is actually associated with a malicious operator. A user may believe they are communicating with a legitimate known person when in reality, they are communicating with a malicious operator or program.

Another related attack is where font on the victim's machine is replaced with a modified version of the font that misleads the user into signing an invalid, malicious document with their digital signature. In a variant attack, instead of faking with different character encoding, misleading elements may be displayed with text that is altered such that it is difficult for a user to recognize the altered text. For example, the malware may change the symbol width so that misleading parts of text flow out of the rendering box. In another example, a transparent overlay may cause a user to select a string link the user did not see. In addition, in some modern file formats for an electronic document exchange like DOCX, some applications (e.g., portable document format (PDF), etc.) do not embed glyphs in the document and can leave fonts externally loadable and thus the document can become vulnerable to such attacks

In some examples, the actual string link is in International Domain Name Notation (IDN). Attacks using IDN homographs rely on users falling for Unicode or ASCII characters that appear similar to Latin characters and attackers host a malicious site and lure potential victims to the malicious site and expose them to exploits or malware downloads. For a homograph attack, the only known solution is a blacklist of domain names. However, blacklists of domain names are hard to maintain, especially with international domains. For a font replacement attack, current solutions either embed glyphs in documents to preserve the same rendering or use document formats that maintain rendered image (graphics like TIFF/PNG, XPS, etc.). Regarding embedded glyphs, embedding glyphs in documents increases the size of documents and limits editing features if the graphics are included. What is needed is a system and method to identify a spoofed string.

A system for the identification of a malicious string, as outlined in FIG. 1 can resolve these issues (and others). System 100 can include a rendering means (e.g., rendering engine 120) that produces a first visual representation of a string, an OCR means (e.g., OCR engine 122) that converts the first visual representation of the string to text, a comparator (e.g., comparator engine 124) that compares the string to the text that was created when the OCR means converted the first visual representation of the string to text and determines any differences between the string and the text, and a mark-up means (e.g., mark-up engine 126) to emphasize or bring attention of any differences to the user. System 100 can include a feedback loop with a string source (e.g., browser, office application, etc.) that allows comparison of what is supposed to be displayed (as machine readable content) with what is displayed on a display (human-readable content). System 100 can be configured to employ an OCR process, strained through configuration parameters such as the user's locale, language preference, etc., to correct a rendered view of what is displayed for comparison with the direct interpretation of what is coded as the string.

In one illustrative example, a phishing attacker attempts to trick a user to click on a string link for google.com by baiting the user into believing the user is going to google.com (the user not being alert to the subtle nuance of “g” in one font and “g” in a different language script and/or font). System 100 uses OCR and a configured locale so that the rendered google.com is reinterpreted as google.com and then compared back with google.com. This in effect compares what is visible (and how the user will interpret what is on the display, in light of a configured locale) against what is coded. Suspicious divergences can be highlighted so the difference between ‘g’ and ‘g’ would become clear and the malicious string can be identified. This helps keep the user from being tricked into clicking on phishing string links, acting on incorrect data, etc.

System 100 does not know if the intended URL is a valid or malicious URL. System 100 helps to detect when what is in the actual string link, when constrained (or mapped) to the user's locale, differs from how the displayed string link appears on the display and is interpreted by the user. Once alerted, the user can judge if the difference is suspicious or normal, especially if the difference is in a URL that it would be quite natural for an unsuspecting user to just click by force of habit.

In some examples, additional diagnostics can be used to give the user more clues such as highlighted areas, displaying the original information including its source representation (e.g., HTML codes), a notification that draws attention to the use of characters from different locales, domains that look similar to a legitimate domain but are different, etc. This can be done by using a different character that looks similar to an English character or a different font and can help alert the user to malicious strings where the actual string is different than what the user is seeing or interpreting (e.g., fun-tagged.com (a fictional safe website) vs a malicious website such as [symbol] un- [symbol] agged.com, fun-ta [symbol] e [symbol] .com, [symbol] -tagged.com, etc.). In addition, on the display, a font may look similar to surrounding font but if printed, the font would be different. If a malicious operator was wanting a digital signature, the signer may never print the document and may never see what they are signing but only see what is displayed, especially if there is a transparent overlay, invisible font, etc. that hides a string link or data such that the string link or data is not visible on the display.

For browsers, security engine 114 can detect string link locations using a domain object model (DOM) and record an image of the string link location displayed on display 116 to the user in order to identify potential untrusted string links. DOM is a cross-platform and language-independent application programming interface (API) that treats an HTML, XHTML, or XML document as a tree structure where each node is an object representing a part of the document. DOM defines the logical structure of documents and the way a document is accessed and manipulated. In the DOM specification, the term “document” is used in the broad sense. Increasingly, XML is being used as a way of representing many different kinds of data that may be stored in diverse systems and much of the data would traditionally be seen as data rather than as documents. Nevertheless, XML presents this data as documents and the DOM may be used to manage this data.

Turning to the infrastructure of FIG. 1, system 100 in accordance with an example embodiment is shown. Generally, system 100 can be implemented in any type or topology of networks. Network 106 represents a series of points or nodes of interconnected communication paths for receiving and transmitting packets of information that propagate through system 100. Network 106 offers a communicative interface between nodes, and may be configured as any local area network (LAN), virtual local area network (VLAN), wide area network (WAN), wireless local area network (WLAN), metropolitan area network (MAN), Intranet, Extranet, virtual private network (VPN), and any other appropriate architecture or system that facilitates communications in a network environment, or any suitable combination thereof, including wired and/or wireless communication.

In system 100, network traffic, which is inclusive of packets, frames, signals, data, etc., can be sent and received according to any suitable communication messaging protocols. Suitable communication messaging protocols can include a multi-layered scheme such as Open Systems Interconnection (OSI) model, or any derivations or variants thereof (e.g., Transmission Control Protocol/Internet Protocol (TCP/IP), user datagram protocol/IP (UDP/IP)). Additionally, radio signal communications over a cellular network may also be provided in system 100. Suitable interfaces and infrastructure may be provided to enable communication with the cellular network.

The term “packet” as used herein, refers to a unit of data that can be routed between a source node and a destination node on a packet switched network. A packet includes a source network address and a destination network address. These network addresses can be Internet Protocol (IP) addresses in a TCP/IP messaging protocol. The term “data” as used herein, refers to any type of binary, numeric, voice, video, textual, or script data, or any type of source or object code, or any other suitable information in any appropriate format that may be communicated from one point to another in electronic devices and/or networks. Additionally, messages, requests, responses, and queries are forms of network traffic, and therefore, may comprise packets, frames, signals, data, etc.

Network elements 102a-102d can each be a network element, desktop computer, laptop computer, mobile device, personal digital assistant, smartphone, tablet, or other similar device that includes a display where a string (e.g., a string link) can be displayed to a user. Cloud services 104 is configured to provide cloud services to network elements 102a-102d. Cloud services may generally be defined as the use of computing resources that are delivered as a service over a network, such as the Internet. Typically, compute, storage, and network resources are offered in a cloud infrastructure, effectively shifting the workload from a local network to the cloud network. Network elements 102a-102d may include any suitable hardware, software, components, modules, or objects that facilitate the operations thereof, as well as suitable interfaces for receiving, transmitting, and/or otherwise communicating data or information in a network environment. This may be inclusive of appropriate algorithms and communication protocols that allow for the effective exchange of data or information.

In regards to the internal structure associated with system 100, each of network element 102a-102d and cloud services 104 can include memory elements (e.g., memory 108) for storing information to be used in the operations outlined herein. Each of network elements 102a-102d and cloud services 104 may keep information in any suitable memory element (e.g., random access memory (RAM), read-only memory (ROM), erasable programmable ROM (EPROM), electrically erasable programmable ROM (EEPROM), application specific integrated circuit (ASIC), etc.), software, hardware, firmware, or in any other suitable component, device, element, or object where appropriate and based on particular needs. Any of the memory items discussed herein should be construed as being encompassed within the broad term ‘memory element.’ Moreover, the information being used, tracked, sent, or received in system 100 could be provided in any database, register, queue, table, cache, control list, or other storage structure, all of which can be referenced at any suitable timeframe. Any such storage options may also be included within the broad term ‘memory element’ as used herein.

In certain example implementations, the functions outlined herein may be implemented by logic encoded in one or more tangible media (e.g., embedded logic provided in an ASIC, digital signal processor (DSP) instructions, software (potentially inclusive of object code and source code) to be executed by a processor, or other similar machine, etc.), which may be inclusive of non-transitory computer-readable media. In some of these instances, memory elements can store data used for the operations described herein. This includes the memory elements being able to store software, logic, code, or processor instructions that are executed to carry out the activities described herein.

In an example implementation, network elements of system 100, such as network elements 102a-102d and cloud services 104 may include software modules (e.g., security engine 114, rendering engine 120, OCR engine 122, comparator engine 124, mark-up engine 126, etc.) to achieve, or to foster, operations as outlined herein. These modules may be suitably combined in any appropriate manner, which may be based on particular configuration and/or provisioning needs. In example embodiments, such operations may be carried out by hardware, implemented externally to these elements, or included in some other network device to achieve the intended functionality. Furthermore, the modules can be implemented as software, hardware, firmware, or any suitable combination thereof. These elements may also include software (or reciprocating software) that can coordinate with other network elements in order to achieve the operations, as outlined herein.

Additionally, each of network elements 102a-102d and cloud services 104 may include a processor (e.g., CPU 110) that can execute software or an algorithm to perform activities as discussed herein. A processor can execute any type of instructions associated with the data to achieve the operations detailed herein. In one example, the processors could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array (FPGA), an EPROM, an EEPROM) or an ASIC that includes digital logic, software, code, electronic instructions, or any suitable combination thereof. Any of the potential processing elements, modules, and machines described herein should be construed as being encompassed within the broad term ‘processor.’

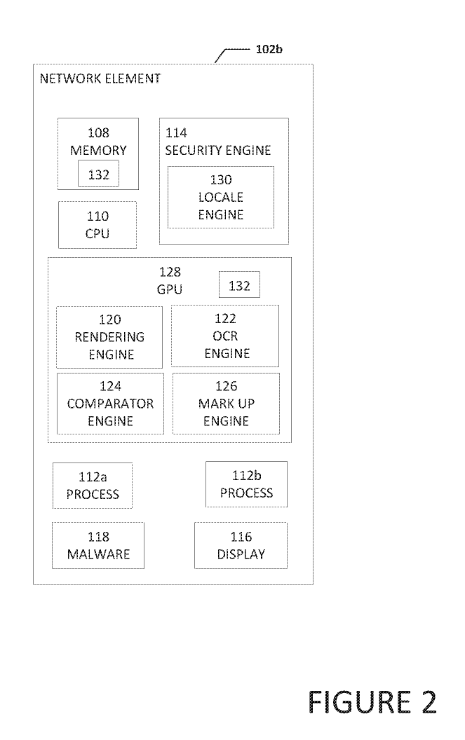

Turning to FIG. 2, FIG. 2 is a simplified block diagram of a portion of a system 100 for the identification of a malicious string in accordance with an embodiment of the present disclosure. In an example, network element 102b can include memory 108, CPU 110, processes 112a and 112b, security engine 114, display 116, and a graphics processing unit (GPU) 128. Memory 108 can include a frame buffer 132. Security engine 114 can include a locale engine 130. GPU 128 can include rendering engine 120, OCR engine 122, comparator engine 124, and mark-up engine 126. In an example, network element 102b can include malware 118.

Frame buffer 132 is a frame buffer, frame store screen buffer, video buffer, regeneration buffer, regen buffer, etc. that is a part of memory used by an application or process (e.g., process 112a or malware 118) for the representation of content to be shown on display 116. Frame buffer 132 can be a portion of RAM that includes a bitmap that drives a video display. Most video cards contain frame buffer circuitry in their cores that can convert an in-memory bitmap into a video signal that can be displayed on display 112. In an example, GPU 128 includes frame buffer 132

GPU 128 is programmable logic chip that is specialized for display functions and can render images, animations, and video for display 112. In an example, GPU 128 may be on a plug-in card, in a chipset on a motherboard, or in the same chip as CPU 110. In another example, GPU 128 is what causes a string or string link to be displayed on display 112. In an example, when GPU 128 includes frame buffer 132, system 100 can take advantage of the fact that frame buffer 132 is a part of or owned by GPU 128 which means GPU 128 has trusted access to frame buffer 132. In addition, GPU 128 can be configured to efficiently implement/offload OCR tasks (e.g., a neural network implementation, image segmentation, preprocessing, etc.).

Locale engine 130 can be configured to determine the location and/or native language of the user. If the user is an English-speaking user, then the characters on display 112 should be English characters and not Latin, Russian, or some other language. For example, locale engine 130 can analyze the language settings on an OS running on network element 102b to determine the native language of the user. Also, locale engine 130 can be configured to determine if the user understands two languages, like English and French, (e.g., a document locale or origination was originally in French or from a French website, the user often travels to France, the user often visits French websites, the user often downloads content in French, etc.). Locale engine 130 can communicate the native language or that the user knows two or more languages to comparator engine 124 and comparator engine 124 can take the native language or that the user knows two or more languages into account when comparing the displayed string link on display 112 to the actual string link in the document. For example, an “m” in English, an “m” in Russian, or an “m” in some other language may be different. Locale engine 130 can help comparator engine 124 to determine if the difference matches what the user is seeing or expecting.

Rendering engine 120 produces a first visual representation of the string (e.g., document, string link, or the URL that is to be rendered). Rendering engine 120 sends the visual representation of the string to OCR engine 122. OCR engine 122 is configured to use the current locale and document locale settings and produce a second visual artifact that is representative of how the original string should have been rendered with the locale settings taken into account. This output from OCR engine 122 is send to comparator engine 124 where it is compared with the first visual representation from rendering engine 120. If comparator engine 124 determines there is a difference, comparator engine 124 communicates the difference to mark-up engine 126. Mark-up engine 126 alerts the user to the differences directly in the first visual representation, in a temporary copy of the original string, or by using some other means to alert the user of the differences. The marked-up string or visual artifact is then re-rendered for presentation to the user so that discrepancies are visually amplified.

Rendering engine 120 can be part of an application/browser (e.g., WebKit library) or part of an Operating System (text drawing functions). Rendering engine 120 takes the specification of what, where and how a string should be presented and translates it into an image (e.g., matrix of pixels with different colors). Rendering engine 120 can be extended to provide details of exact location and dimension of text areas. If rendering engine 120 is based on relatively low-level functions (display text string at specific location), then the details about the rendered image is known at the start. In more complex scenarios, rendering engine 120 may have to compute the rendered image details based on a specification (e.g., HTML/CSS). Rendering engine 120 can be configured to receive text specifications and output an image based on the text specifications, as well as dimensions and locations of the text areas with text data expected to be there as per the text specification.

OCR engine 122 can be configured to receive an image provided by rendering engine 120 and apply a recognition algorithm to perform the OCR on the image and translate the image into text. In an example, OCR engine 122 may use data from locale engine 130 to help determine a current locale and language or languages know to the user and use the current locale and language or languages know to the user when performing the OCR on the image created by rendering engine 120. For example, OCR engine 122 can internally maintain data on how various symbols specific for a locale and language are represented or encoded in accordance with a recognition algorithm (e.g., image segmentation, neural networks, etc.). OCR engine 122 can also include orthography checks to clarify locale of text. For example, a “P” in a first language and a “P” in a second different language look similar and OCR engine 122 can determine what language group is applicable based on other letters and what would create a meaningful word in the language or languages know to the user. OCR engine 122 can receive an image from rendering engine 120, location of text areas, locale and language of the string from locale engine 130, etc. and output recognized texts. In an example, the recognized texts may be multiple variants, (e.g., MAMA in Russian and MAMA in English may be valid).

Comparator engine 124 can be configured to receive the recognized text from OCR engine 122 and compare the recognized text with the original string, referenced by rendering engine 120. If the data does not match, comparator engine 124 can issue a command to mark-up engine 126 to highlight mismatching parts on display 112.

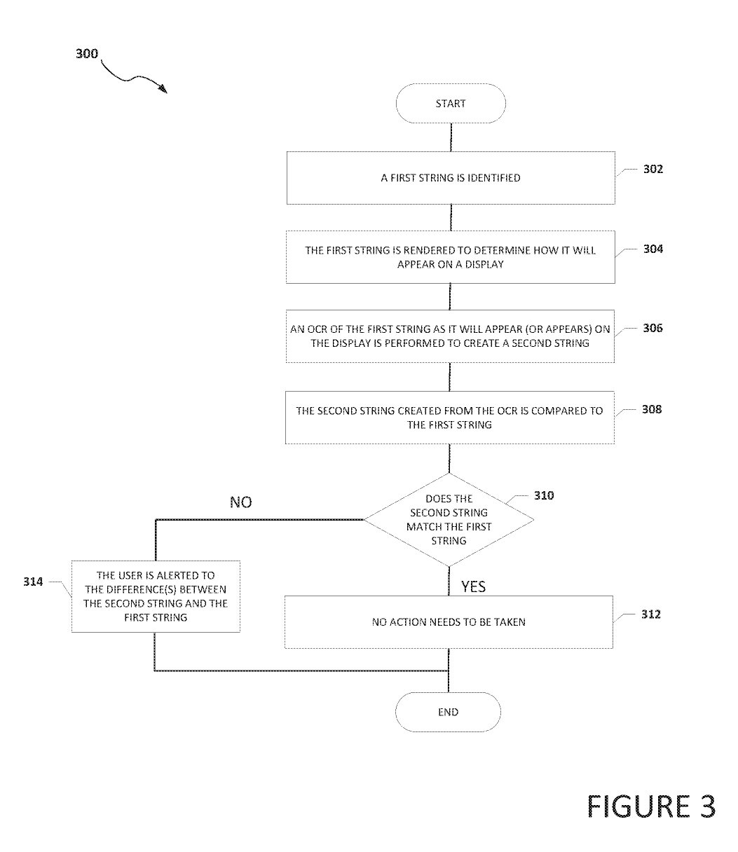

Turning to FIG. 3, FIG. 3 is an example flowchart illustrating possible operations of a flow 300 that may be associated with the identification of a malicious string, in accordance with an embodiment. In an embodiment, one or more operations of flow 300 may be performed by security engine 114, rendering engine 120, OCR engine 122, comparator engine 124, and/or mark-up engine 126. At 302, a first string is identified. For example, the first string may be part of a document or data and the first string may be a string link to a webpage. At 304, the first string is rendered to determine how it will appear on a display. At 306, an OCR of the first string as it will appear (or appears) on the display is performed to create a second string. At 308, the second string created from the OCR is compared to the first string. At 310, the system determines if the second string matches the first string. If the second string matches the first string, then no action needs to be taken, as in 312. If the second string does not match the first string, then the user is alerted to the difference(s) between the second string and the first string, as in 314. For example, the differences between the second string and the first string can be highlighted on display 116 so the user can see the differences and identify a potentially malicious string.

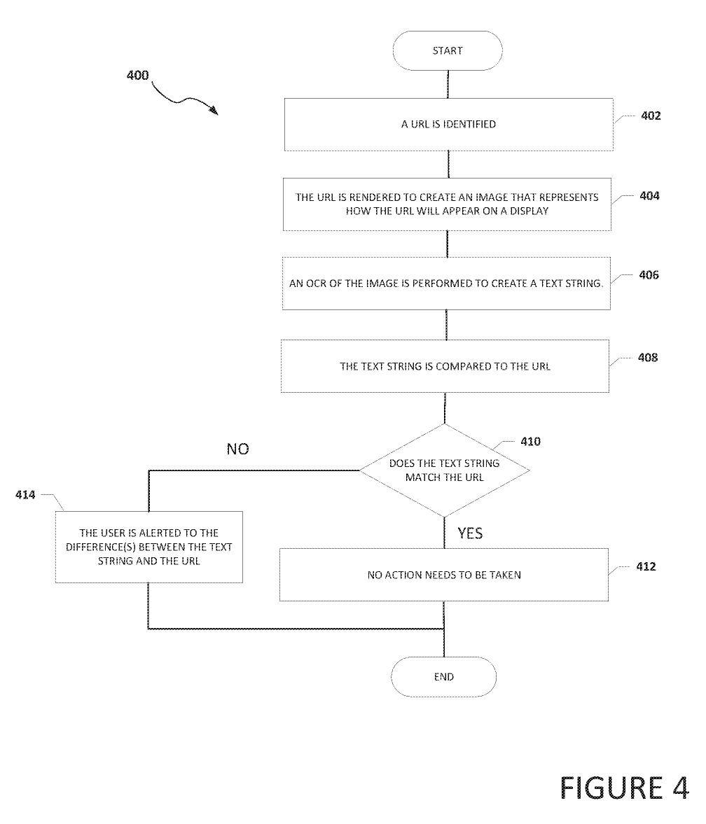

Turning to FIG. 4, FIG. 4 is an example flowchart illustrating possible operations of a flow 400 that may be associated with the identification of a malicious string, in accordance with an embodiment. In an embodiment, one or more operations of flow 400 may be performed by security engine 114, rendering engine 120, OCR engine 122, comparator engine 124, and/or mark-up engine 126. At 402, a URL is identified. At 404, the URL is rendered to create an image that represents how the URL will appear on a display. At 406, an OCR of the image is performed to create a text string. At 408, the text string is compared to the URL. At 410, the system determines if the text string matches the URL. If the text string matches the URL, then no action needs to be taken, as in 412. If the text string does not match the URL, then the user is alerted to the difference(s) between the text string and the URL, as in 414. For example, the differences between the URL and the text string can be highlighted on display 116 so the user can see the differences and identify a potentially malicious string.

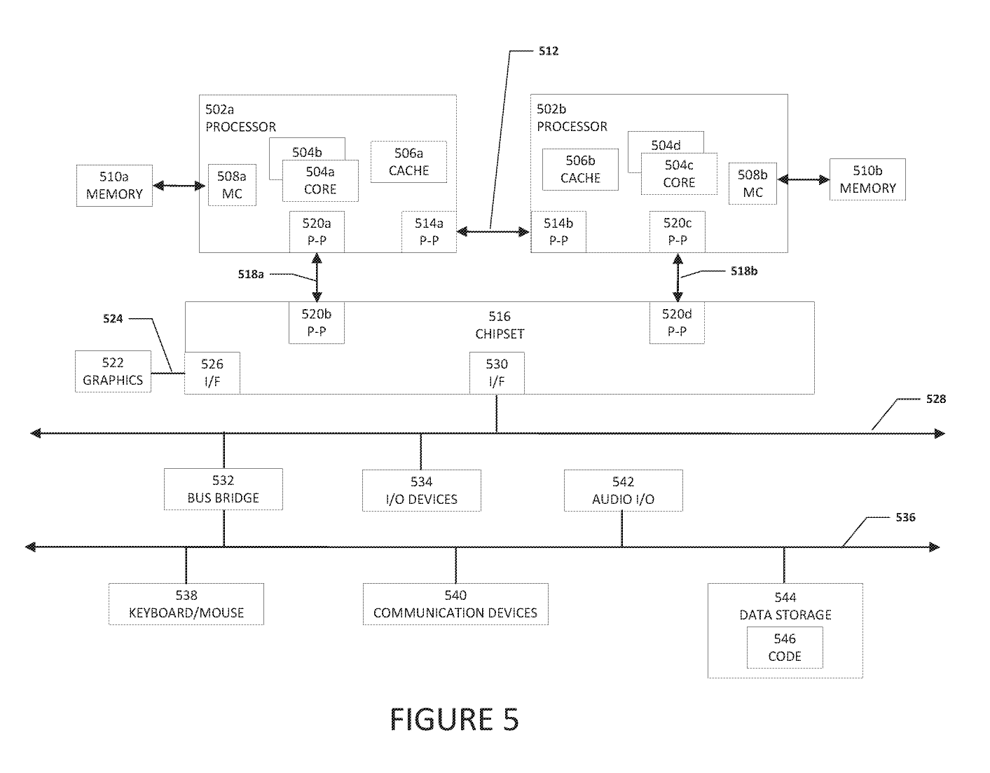

Turning to FIG. 5, FIG. 5 illustrates a computing system 500 that is arranged in a point-to-point (PtP) configuration according to an embodiment. In particular, FIG. 5 shows a system where processors, memory, and input/output devices are interconnected by a number of point-to-point interfaces. Generally, one or more of the network elements of system 100 may be configured in the same or similar manner as computing system 500.

As illustrated in FIG. 5, system 500 may include several processors, of which only two, processors 502a and 502b, are shown for clarity. While two processors 502a and 502b are shown, it is to be understood that an embodiment of system 500 may also include only one such processor. Processors 502a and 502b may each include a set of cores (i.e., processors cores 504a and 504b and processors cores 504c and 504d) to execute multiple threads of a program. The cores may be configured to execute instruction code in a manner similar to that discussed above with reference to FIGS. 1-8. Each processor 502a and 502b may include at least one shared cache 506a and 506b respectively. Shared caches 506a and 506b may each store data (e.g., instructions) that are utilized by one or more components of processors 502a and 502b, such as processor cores 504a and 504b of processor 502a and processor cores 504c and 504d of processor 502b.

Processors 502a and 502b may also each include integrated memory controller logic (MC) 508a and 508b respectively to communicate with memory elements 510a and 510b. Memory elements 510a and/or 510b may store various data used by processors 502a and 502b. In alternative embodiments, memory controller logic 508a and 508b may be discrete logic separate from processors 502a and 502b.

Processors 502a and 502b may be any type of processor and may exchange data via a point-to-point (PtP) interface 512 using point-to-point interface circuits 514a and 514b respectively. Processors 502a and 502b may each exchange data with a chipset 516 via individual point-to-point interfaces 518a and 518b using point-to-point interface circuits 520a-520d. Chipset 516 may also exchange data with a high-performance graphics circuit 522 via a high-performance graphics interface 524, using an interface circuit 526, which could be a PtP interface circuit. In alternative embodiments, any or all of the PtP links illustrated in FIG. 5 could be implemented as a multi-drop bus rather than a PtP link.

Chipset 516 may be in communication with a bus 528 via an interface circuit 530. Bus 528 may have one or more devices that communicate over it, such as a bus bridge 532 and I/O devices 534. Via a bus 536, bus bridge 532 may be in communication with other devices such as a keyboard/mouse 538 (or other input devices such as a touch screen, trackball, etc.), communication devices 540 (such as modems, network interface devices, or other types of communication devices that may communicate through a network), audio I/O devices 542, and/or a data storage device 544. Data storage device 544 may store code 546, which may be executed by processors 502a and/or 502b. In alternative embodiments, any portions of the bus architectures could be implemented with one or more PtP links.

The computer system depicted in FIG. 5 is a schematic illustration of an embodiment of a computing system that may be utilized to implement various embodiments discussed herein. It will be appreciated that various components of the system depicted in FIG. 5 may be combined in a system-on-a-chip (SoC) architecture or in any other suitable configuration. For example, embodiments disclosed herein can be incorporated into systems including mobile devices such as smart cellular telephones, tablet computers, personal digital assistants, portable gaming devices, etc. It will be appreciated that these mobile devices may be provided with SoC architectures in at least some embodiments.

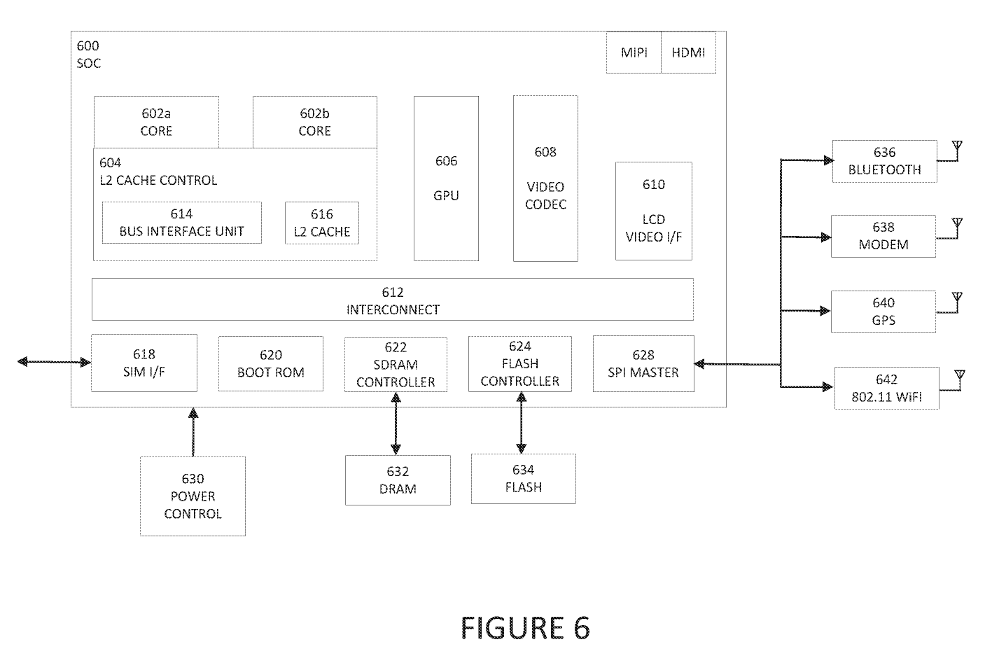

Turning to FIG. 6, FIG. 6 is a simplified block diagram associated with an example ecosystem SOC 600 of the present disclosure. At least one example implementation of the present disclosure can include the device pairing in a local network features discussed herein and an ARM component. For example, the example of FIG. 6 can be associated with any ARM core (e.g., A-9, A-15, etc.). Further, the architecture can be part of any type of tablet, smartphone (inclusive of Android™ phones, iPhones™), iPad™, Google Nexus™, Microsoft Surface™, personal computer, server, video processing components, laptop computer (inclusive of any type of notebook), Ultrabook™ system, any type of touch-enabled input device, etc.

In this example of FIG. 6, ecosystem SOC 600 may include multiple cores 602a and 602b, an L2 cache control 604, a graphics processing unit (GPU) 606, a video codec 608, a liquid crystal display (LCD) I/F 610 and an interconnect 612. L2 cache control 604 can include a bus interface unit 614, a L2 cache 616. Liquid crystal display (LCD) I/F 610 may be associated with mobile industry processor interface (MIPI)/high-definition multimedia interface (HDMI) links that couple to an LCD.

Ecosystem SOC 600 may also include a subscriber identity module (SIM) I/F 618, a boot read-only memory (ROM) 620, a synchronous dynamic random-access memory (SDRAM) controller 622, a flash controller 624, a serial peripheral interface (SPI) master 628, a suitable power control 630, a dynamic RAM (DRAM) 632, and flash 634. In addition, one or more embodiments include one or more communication capabilities, interfaces, and features such as instances of Bluetooth™ 636, a 3G modem 0138, a global positioning system (GPS) 640, and an 802.11 Wi-Fi 642.

In operation, the example of FIG. 6 can offer processing capabilities, along with relatively low power consumption to enable computing of various types (e.g., mobile computing, high-end digital home, servers, wireless infrastructure, etc.). In addition, such an architecture can enable any number of software applications (e.g., Android™, Adobe® Flash® Player, Java Platform Standard Edition (Java SE), JavaFX, Linux, Microsoft Windows Embedded, Symbian and Ubuntu, etc.). In at least one example embodiment, the core processor may implement an out-of-order superscalar pipeline with a coupled low-latency level-2 cache.

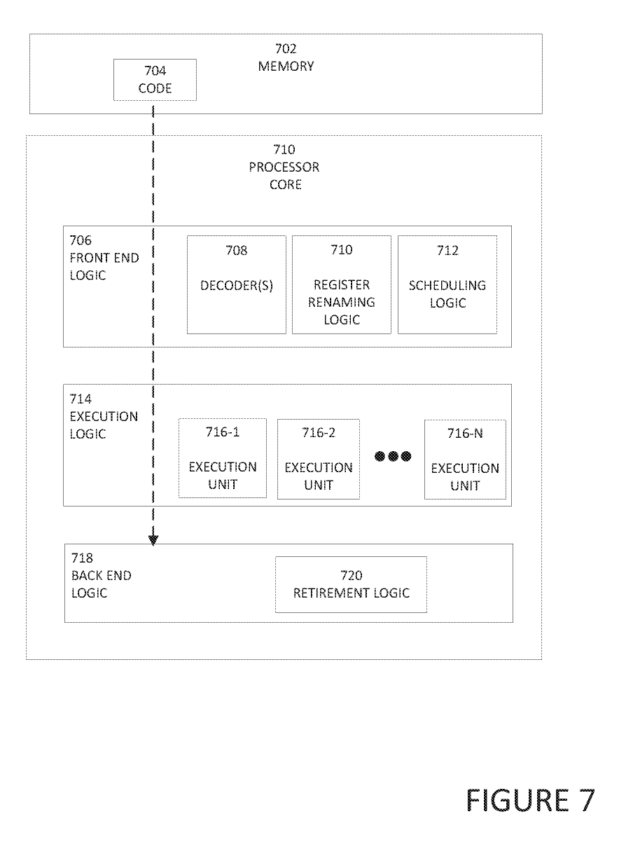

Turning to FIG. 7, FIG. 7 illustrates a processor core 700 according to an embodiment. Processor core 700 may be the core for any type of processor, such as a micro-processor, an embedded processor, a digital signal processor (DSP), a network processor, or other device to execute code. Although only one processor core 700 is illustrated in FIG. 7, a processor may alternatively include more than one of the processor core 700 illustrated in FIG. 7. For example, processor core 700 represents one example embodiment of processors cores 574a, 574b, 584a, and 584b shown and described with reference to processors 502a and 502b of FIG. 5. Processor core 700 may be a single-threaded core or, for at least one embodiment, processor core 700 may be multithreaded in that it may include more than one hardware thread context (or “logical processor”) per core.

FIG. 7 also illustrates a memory 702 coupled to processor core 700 in accordance with an embodiment. Memory 702 may be any of a wide variety of memories (including various layers of memory hierarchy) as are known or otherwise available to those of skill in the art. Memory 702 may include code 704, which may be one or more instructions, to be executed by processor core 700. Processor core 700 can follow a program sequence of instructions indicated by code 704. Each instruction enters a front-end logic 706 and is processed by one or more decoders 708. The decoder may generate, as its output, a micro operation such as a fixed width micro operation in a predefined format, or may generate other instructions, microinstructions, or control signals that reflect the original code instruction. Front-end logic 706 also includes register renaming logic 710 and scheduling logic 712, which generally allocate resources and queue the operation corresponding to the instruction for execution.

Processor core 700 can also include execution logic 714 having a set of execution units 716-1 through 716-N. Some embodiments may include a number of execution units dedicated to specific functions or sets of functions. Other embodiments may include only one execution unit or one execution unit that can perform a particular function. Execution logic 714 performs the operations specified by code instructions.

After completion of execution of the operations specified by the code instructions, back-end logic 718 can retire the instructions of code 704. In one embodiment, processor core 700 allows out of order execution but requires in order retirement of instructions. Retirement logic 720 may take a variety of known forms (e.g., re-order buffers or the like). In this manner, processor core 700 is transformed during execution of code 704, at least in terms of the output generated by the decoder, hardware registers and tables utilized by register renaming logic 710, and any registers (not shown) modified by execution logic 714.

Although not illustrated in FIG. 7, a processor may include other elements on a chip with processor core 700, at least some of which were shown and described herein with reference to FIG. 5. For example, as shown in FIG. 5, a processor may include memory control logic along with processor core 700. The processor may include I/O control logic and/or may include I/O control logic integrated with memory control logic.

Note that with the examples provided herein, interaction may be described in terms of two, three, or more network elements. However, this has been done for purposes of clarity and example only. In certain cases, it may be easier to describe one or more of the functionalities of a given set of flows by only referencing a limited number of network elements. It should be appreciated that system 100 and its teachings are readily scalable and can accommodate a large number of components, as well as more complicated/sophisticated arrangements and configurations. Accordingly, the examples provided should not limit the scope or inhibit the broad teachings of system 100 as potentially applied to a myriad of other architectures.

It is also important to note that the operations in the preceding flow diagrams (i.e., FIGS. 3-5) illustrate only some of the possible correlating scenarios and patterns that may be executed by, or within, system 100. Some of these operations may be deleted or removed where appropriate, or these operations may be modified or changed considerably without departing from the scope of the present disclosure. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by system 100 in that any suitable arrangements, chronologies, configurations, and timing mechanisms may be provided without departing from the teachings of the present disclosure.

Although the present disclosure has been described in detail with reference to particular arrangements and configurations, these example configurations and arrangements may be changed significantly without departing from the scope of the present disclosure. Moreover, certain components may be combined, separated, eliminated, or added based on particular needs and implementations. Additionally, although system 100 has been illustrated with reference to particular elements and operations that facilitate the communication process, these elements and operations may be replaced by any suitable architecture, protocols, and/or processes that achieve the intended functionality of system 100

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

### OTHER NOTES AND EXAMPLES

Example C1 is at least one machine readable medium having one or more instructions that when executed by at least one processor cause the at least one processor to identify a string of data to be displayed on a display, render the string of data to create an image that represents how the string of data will be displayed on the display, perform object character recognition (OCR) on the image to create a string of OCR data, compare the string of OCR data to the string of data to determine if there is a difference between the string of OCR data and the string of data, and communicate an alert to a user when there is a difference between the string of OCR data and the string of data.

In Example C2, the subject matter of Example C1 can optionally include where the string of data is a link to a website.

In Example C3, the subject matter of any one of Examples C1-C2 can optionally include one or more instructions that when executed by the least one processor, causes the least one processor to determine one or more languages to be associated with the user, where the OCR of the image is based on the one or more languages of the user.

In Example C4, the subject matter of any one of Examples C1-C3 can optionally where the difference between the string of OCR data and the string of data is a difference in language.

In Example C5, the subject matter of any one of Examples C1-C4 can optionally include where the difference between the string of OCR data and the string of data is a font difference.

In Example C6, the subject matter of any one of Examples C1-C5 can optionally include where the difference between the string of OCR data and the string of data includes one or more International Domain Name Notation homographs.

In Example C7, the subject matter of any one of Example C1-C6 can optionally include where the string of data is a link to a malicious website.

In Example A1, an electronic device can include memory, at least one processor, and a security engine. The security engine is configured to identify a string of data to be displayed on a display, render the string of data to create an image that represents how the string of data will be displayed on the display, perform object character recognition (OCR) of the image to create a string of OCR data, compare the string of OCR data and the string of data to determine if there is a difference between the string of OCR data and the string of data, and communicate an alert to a user when there is a difference between the string of OCR data and the string of data.

In Example, A2, the subject matter of Example A1 can optionally include where the string of data is a link to a website.

In Example A3, the subject matter of any one of Examples A1-A2 can optionally include where the security engine if further configured to determine one or more languages to be associated with the user, where the OCR of the image is based on the one or more languages of the user.

In Example A4, the subject matter of any one of Examples A1-A3 can optionally include where the difference between the string of OCR data and the string of data is a difference in language.

In Example A5, the subject matter of any one of Examples A1-A4 can optionally include where the difference between the string of OCR data and the string of data is a font difference.

In Example A6, the subject matter of any one of Examples A1-A5 can optionally include where the difference between the OCR data and the string of data includes one or more International Domain Name Notation homographs.

In Example A7, the subject matter of any one of Examples A1-A6 can optionally include where the string of data is a link to a malicious website.

Example M1 is a method including identifying a string of data to be displayed on a display, rendering the string of data to create an image that represents how the string of data will be displayed on the display, performing object character recognition (OCR) of the image to create a string of OCR data, comparing the string of OCR data and the string of data to determine if there is a difference between the string of OCR data and the string of data, and communicating an alert to a user when there is a difference between the string of OCR data and the string of data.

In Example M2, the subject matter of Example M1 can optionally include where the string of data is a link to a website.

In Example M3, the subject matter of any one of the Examples M1-M2 can optionally include determining one or more languages to be associated with the user, where the OCR of the image is based on the one or more languages of the user.

In Example M4, the subject matter of any one of the Examples M1-M3 can optionally include where the difference between the string of OCR data and the string of data is a difference in language.

In Example M5, the subject matter of any one of the Examples M1-M4 can optionally include where the difference between the string of OCR data and the string of data is a font difference.

In Example M6, the subject matter of any one of the Examples M1-M5 can optionally include where the difference between the string of OCR data and the string of data includes one or more International Domain Name Notation homographs.

In Example M7, the subject matter of any one of the Examples M1-M6 can optionally include where the string of data is a link to a malicious website.

Example S1 is a system for discovering a malicious string, the system including a security engine configured to identify a string of data to be displayed on a display, a rendering engine configured to render the string of data to create an image that represents how the string of data will be displayed on the display, an object character recognition (OCR) engine configured to perform OCR of the image to create a string of OCR data, a comparator engine configured to compare the string of OCR data and the string of data to determine if there is a difference between the string of OCR data and the string of data, and a mark-up engine configured to communicate an alert to a user when there is a difference between the string of OCR data and the string of data.

In Example S2, the subject matter of Example S1 can optionally include where the string of data is a link to a website.

In Example S3, the subject matter of any of the Examples S1-S2 can optionally include a locale engine configured to determine one or more languages to be associated with the user, where the OCR of the image is based on the one or more languages of the user.

In Example S4, the subject matter of any of the Examples S1-S3 can optionally include where the difference between the string of OCR data and the string of data is a difference in language.

Example AA1 is an electronic device including means for means for identifying a string of data to be displayed on a display, render the string of data to create an image that represents how the string of data will be displayed on the display, means for performing object character recognition (OCR) on the image to create a string of OCR data, means for comparing the string of OCR data to the string of data to determine if there is a difference between the string of OCR data and the string of data, and means for communicating an alert to a user when there is a difference between the string of OCR data and the string of data.

In Example AA2, the subject matter of Example AA1 can optionally include where the string of data is a link to a website.

In Example AA3, the subject matter of any one of Examples AA1-AA2 can optionally include means for determining one or more languages to be associated with the user, where the OCR of the image is based on the one or more languages of the user.

In Example AA4, the subject matter of any one of Examples AA1-AA3 can optionally include where the difference between the string of OCR data and the string of data is a difference in language.

In Example AA5, the subject matter of any one of Examples AA1-AA4 can optionally include where the difference between the string of OCR data and the string of data is a font difference.

In Example AA6, the subject matter of any one of Examples AA1-AA5 can optionally include where the difference between the string of OCR data and the string of data includes one or more International Domain Name Notation homographs.

In Example AA7, the subject matter of any one of Example AA1-AA6 can optionally include where the string of data is a link to a malicious website.

Example X1 is a machine-readable storage medium including machine-readable instructions to implement a method or realize an apparatus as in any one of the Examples A1-A7, AA1-AA7 or M1-M7. Example Y1 is an apparatus comprising means for performing of any of the Example methods M1-M7. In Example Y2, the subject matter of Example Y1 can optionally include the means for performing the method comprising a processor and a memory. In Example Y3, the subject matter of Example Y2 can optionally include the memory comprising machine-readable instructions.

What is claimed is:

1. At least one machine-readable medium comprising one or more instructions that when executed by at least one processor, cause the at least one processor to:
identify a string of data to be displayed on a display;
render the string of data to create an image that represents how the string of data will be displayed on the display;
perform object character recognition (OCR) on the image to create a string of OCR data;
compare the string of OCR data to the string of data to determine if there is a difference between the string of OCR data and the string of data; and
communicate an alert to a user when there is a difference between the string of OCR data and the string of data.

2. The at least one machine-readable medium of claim 1, wherein the string of data is a link to a website.

3. The at least one machine-readable medium of claim 1, further comprising one or more instructions that when executed by the at least one processor, further cause the processor to:
determine one or more languages to be associated with the user, wherein the OCR of the image is based on the one or more languages of the user.

4. The at least one machine-readable medium of claim 3, wherein the difference between the string of OCR data and the string of data is a difference in language.

5. The at least one machine-readable medium of claim 1, wherein the difference between the string of OCR data and the string of data is a font difference.

6. The at least one machine-readable medium of claim 1, wherein the difference between the string of OCR data and the string of data includes one or more International Domain Name Notation homographs.

7. The at least one machine-readable medium of claim 1, wherein the string of data is a link to a malicious website.

8. An apparatus comprising:
memory; and
security engine configured to:
identify a string of data to be displayed on a display;
render the string of data to create an image that represents how the string of data will be displayed on the display;
perform object character recognition (OCR) of the image to create a string of OCR data;
compare the string of OCR data and the string of data to determine if there is a difference between the string of OCR data and the string of data; and
communicate an alert to a user when there is a difference between the string of OCR data and the string of data.

9. The apparatus of claim 8, wherein the string of data is a link to a website.

10. The apparatus of claim 8, wherein the security engine is further configured to:
determine one or more languages to be associated with the user, wherein the OCR of the image is based on the one or more languages of the user.

11. The apparatus of claim 10, wherein the difference between the string of OCR data and the string of data is a difference in language.

12. The apparatus of claim 8, wherein the difference between the string of OCR data and the string of data is a font difference.

13. The apparatus of claim 8, wherein the difference between the OCR data and the string of data includes one or more International Domain Name Notation homographs.

14. The apparatus of claim 8, wherein the string of data is a link to a malicious website.

15. A method comprising:
identifying a string of data to be displayed on a display;
rendering the string of data to create an image that represents how the string of data will be displayed on the display;
performing object character recognition (OCR) of the image to create a string of OCR data;
comparing the string of OCR data and the string of data to determine if there is a difference between the string of OCR data and the string of data; and
communicating an alert to a user when there is a difference between the string of OCR data and the string of data.

16. The method of claim 15, wherein the string of data is a link to a website.

17. The method of claim 15, further comprising:
determining one or more languages to be associated with the user, wherein the OCR of the image is based on the one or more languages of the user.

18. The method of claim 17, wherein the difference between the string of OCR data and the string of data is a difference in language.

19. The method of claim 15, wherein the difference between the string of OCR data and the string of data is a font difference.

20. The method of claim 15, wherein the difference between the string of OCR data and the string of data includes one or more International Domain Name Notation homographs.

21. The method of claim 15, wherein the string of data is a link to a malicious website.

22. A system for identifying a malicious string, the system comprising:
a security engine configured to identify a string of data to be displayed on a display;
a rendering engine configured to render the string of data to create an image that represents how the string of data will be displayed on the display;
an object character recognition (OCR) engine configured to perform OCR of the image to create a string of OCR data;
a comparator engine configured to compare the string of OCR data and the string of data to determine if there is a difference between the string of OCR data and the string of data; and
a mark-up engine configured to communicate an alert to a user when there is a difference between the string of OCR data and the string of data to allow the user to identify the string of data as a malicious string.

23. The system of claim 22, wherein the string of data is a link to a website.

24. The system of claim 22, further comprising:
a locale engine configured to determine one or more languages to be associated with the user, wherein the OCR of the image is based on the one or more languages of the user.

25. The system of claim 22, wherein the difference between the string of OCR data and the string of data is a difference in language.
